(19) United States
(12) Patent Application Publication
(10) Pub. No.: US 2017/0048898 A1
(43) Pub. Date: Feb. 16, 2017

(54) METHOD FOR DECLARING RADIO LINK FAILURE PERFORMED BY TERMINAL IN WIRELESS COMMUNICATION SYSTEM AND TERMINAL USING THE METHOD

(71) Applicant: LG ELECTRONICS INC., Seoul (KR)

(72) Inventors: Sunghoon Jung, Seoul (KR); Sangwon KIM, Seoul (KR)

(21) Appl. No.: 15/304,256

(22) PCT Filed: Apr. 27, 2015
(86) PCT No.: PCT/KR2015/004187

§ 371 Date: Oct. 14, 2016

Related U.S. Application Data
(60) Provisional application No. 61/984,048, filed on Apr. 25, 2014.

(51) Int. Cl. H04W 76/02; H04W 24/10

(52) U.S. Cl. CPC H04W 76/02; H04W 24/10; H04W 88/02

(57) ABSTRACT

Provided are a method for declaring radio link failure (RLF), performed by a terminal in a wireless communication system, and a terminal using the method. The method is characterized by: determining whether an event for a measurement report is satisfied; starting a timer only for an initial measurement report, when the event has been satisfied; and declaring the radio link failure when the timer has expired.

### CROSS-REFERENCE TO RELATED APPLICATIONS

The present application is the National Stage filing under 35 U.S.C. 371 of International Application No. PCT/KR2015/004187, filed on Apr. 27, 2015, which claims the benefit of U.S. Provisional Application No. 61/984,048 filed on Apr. 25, 2014, the contents of which are all hereby incorporated by reference herein in their entirety.

### BACKGROUND OF THE INVENTION

Field of the Invention

The present invention relates to wireless communications, and more particularly, to a method for declaring radio link failure performed by a terminal in a wireless communication system and a terminal using the method.

Related Art

In an International Telecommunication Union Radio communication sector (ITU-R), a standardization of International Mobile Telecommunication (IMT)-Advanced being a next mobile communication system after a third generation has been performed. The IMT-Advanced is aimed at supporting an Internet Protocol (IP) based multi-media service with a data transmission rate of 1 Gbps in a stop and low speed moving state and a data transmission rate of 1 Gbps in a high speed moving state.

A 3rd Generation Partnership Project (3GPP) is preparing LTE-Advanced (LTE-A) being an improved one of Long Term Evolution (LTE) based on an OFDMA (Orthogonal Frequency Division Multiple Access)/SC-FDMA (Single Carrier-Frequency Division Multiple Access) transmission scheme as a system standard satisfying requirements of IMT-Advanced. The LTE-A is one important candidate for IMT-Advanced.

A terminal continues to perform measurement in order to maintain the quality of a radio link with a serving cell from which the UE receives a service. The terminal determines whether or not communication is impossible in a current situation due to the quality deterioration of the radio link with the serving cell. If communication is almost impossible because the quality of the serving cell is too low, the terminal declares that the current situation is an RLF. Then, the terminal gives up maintaining communication with the current serving cell, selects a new cell according to a cell selection (or reselection) procedure, and attempts RRC connection re-establishment with the new cell.

Suppose that the terminal has a problem in the link with the current serving cell, having determined that it is appropriate to perform a handover from the serving cell to another cell. In this case, it is more effective in reducing service interruption time that the terminal declares an RLF and attempts to establish/reestablish an RRC connection to the target cell than that the terminal attempts to restore the radio link with the current serving cell. Accordingly, the terminal makes an early RLF declaration.

However, the terminal may not make an early RLF declaration in some cases. For example, according to the current standards, when a problem occurs in the link between the current serving cell and the terminal, the terminal operates a first timer. When a measurement report by a specific event is performed during the operation of the first timer, the terminal operates a second timer and makes an early RLF declaration at the expire of the second timer. However, when the measurement report by the specific event is repeated before the second timer expires, the second timer keeps operating without expiring. Then, the terminal cannot make an early RLF declaration, extending service interruption time.

### SUMMARY OF THE INVENTION

An aspect of the present invention is to provide a method for declaring radio link failure performed by a terminal in a wireless communication system and a terminal using the method.

In an aspect, a method for declaring a radio link failure (RLF) performed by a user equipment (UE) in a wireless communication system is provided. The method comprises determining whether an event for a measurement report occurs, starting a timer only with respect to an initial measurement report when the event occurs and declaring an RLF when the timer expires.

The method may further receives a measurement identity indicating an association between a reporting configuration, which indicates the event, and a measurement object, which indicates an object to be measured by the UE.

The reporting configuration relating to the measurement identity may comprise a field indicating use of the timer.

The event may be an event in which a neighboring cell has better signal strength or quality than a serving cell of the UE.

The UE may generate a measurement report when the event occurs, and the measurement report comprises a field indicating number of report times.

The timer may be started only when the field indicating the number of report times has a value of 0.

In another aspect, a user equipment (UE) is provided. The UE comprises a radio frequency (RF) unit that transmit and receive a radio signal and a processor connected to the RF unit to operate, wherein the processor that determines whether an event for a measurement report occurs, starts a timer only with respect to an initial measurement report when the event occurs, and declares an RLF when the timer expires.

According to the present invention, when a radio link with a serving cell deteriorates, a terminal may make an early RLF declaration and may quickly perform an RRC connection re-establishment procedure with a neighboring cell. Accordingly, service interruption time may be reduced.

### BRIEF DESCRIPTION OF THE DRAWINGS

FIG. 1 shows a wireless communication system to which the present invention is applied.

FIG. 2 is a diagram showing a wireless protocol architecture for a user plane.

FIG. 3 is a diagram showing a wireless protocol architecture for a control plane.

FIG. 4 is a flowchart illustrating the operation of UE in the RRC idle state.

FIG. 5 is a flowchart illustrating a procedure of establishing RRC connection.

FIG. 6 is a flowchart illustrating an RRC connection reconfiguration procedure.

FIG. 7 is a diagram illustrating an RRC connection re-establishment procedure.

FIG. 8 is a flowchart illustrating a method for performing measurement.

FIG. 9 illustrates an example of a measurement configuration set for a UE.

FIG. 10 illustrates an example of deleting a measurement ID.

FIG. 11 illustrates an example of deleting a measurement object.

FIG. 12 illustrates sub-states that a UE may have in an RRC_IDLE state and a sub-state transition process.

FIG. 13 illustrates an early RLF declaration.

FIG. 14 illustrates a problem that may occur in an early RLF declaration.

FIG. 15 illustrates an RLF declaration method of a UE according to one embodiment of the present invention.

FIG. 16 is a block diagram of a UE according to an embodiment of the present invention.

### DESCRIPTION OF EXEMPLARY EMBODIMENTS

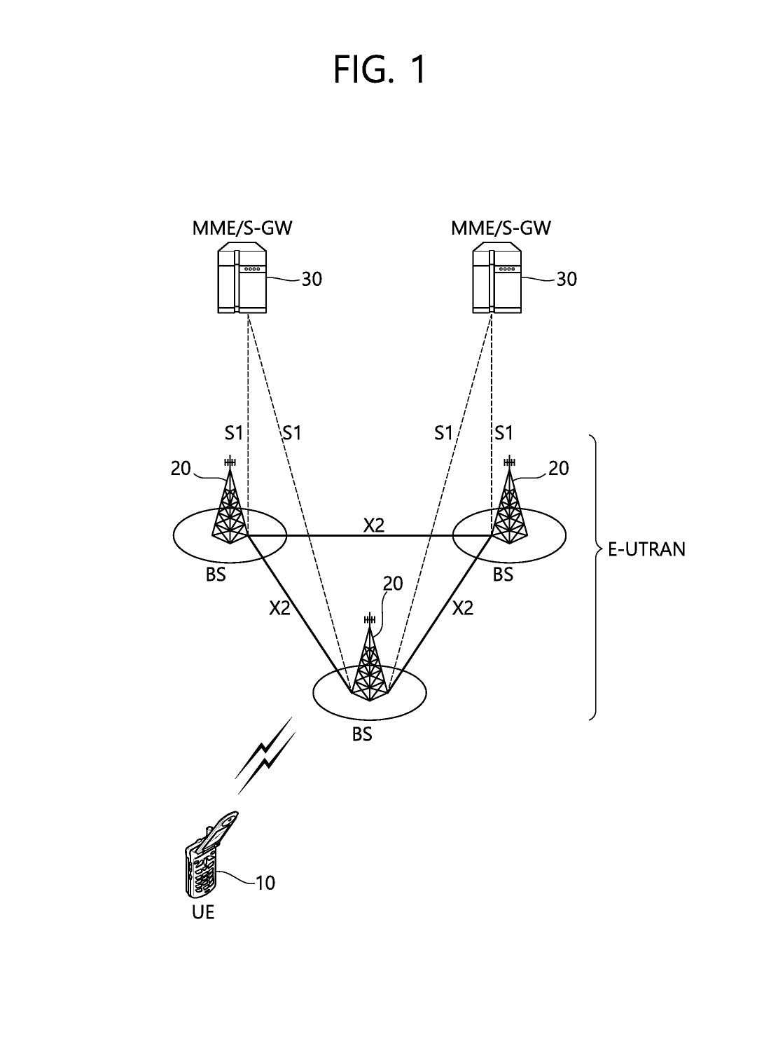

FIG. 1 shows a wireless communication system to which the present invention is applied. The wireless communication system may also be referred to as an evolved-UMTS terrestrial radio access network (E-UTRAN) or a long term evolution (LTE)/LTE-A system.

The E-UTRAN includes at least one base station (BS) 20 which provides a control plane and a user plane to a user equipment (UE) 10. The UE 10 may be fixed or mobile, and may be referred to as another terminology, such as a mobile station (MS), a user terminal (UT), a subscriber station (SS), a mobile terminal (MT), a wireless device, etc. The BS 20 is generally a fixed station that communicates with the UE 10 and may be referred to as another terminology, such as an evolved node-B (eNB), a base transceiver system (BTS), an access point, etc.

The BSs 20 are interconnected by means of an X2 interface. The BSs 20 are also connected by means of an S1 interface to an evolved packet core (EPC) 30, more specifically, to a mobility management entity (MME) through S1-MME and to a serving gateway (S-GW) through S1-U.

The EPC 30 includes an MME, an S-GW, and a packet data network-gateway (P-GW). The MME has access information of the UE or capability information of the UE, and such information is generally used for mobility management of the UE. The S-GW is a gateway having an E-UTRAN as an end point. The P-GW is a gateway having a PDN as an end point.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

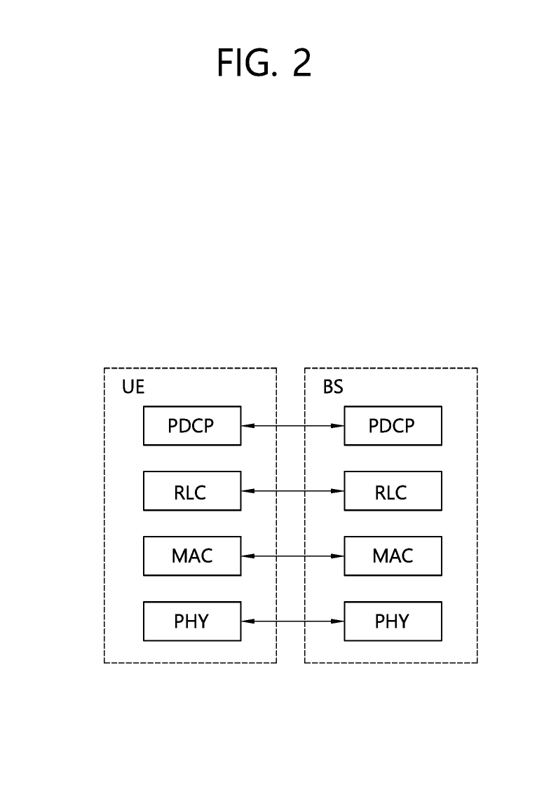

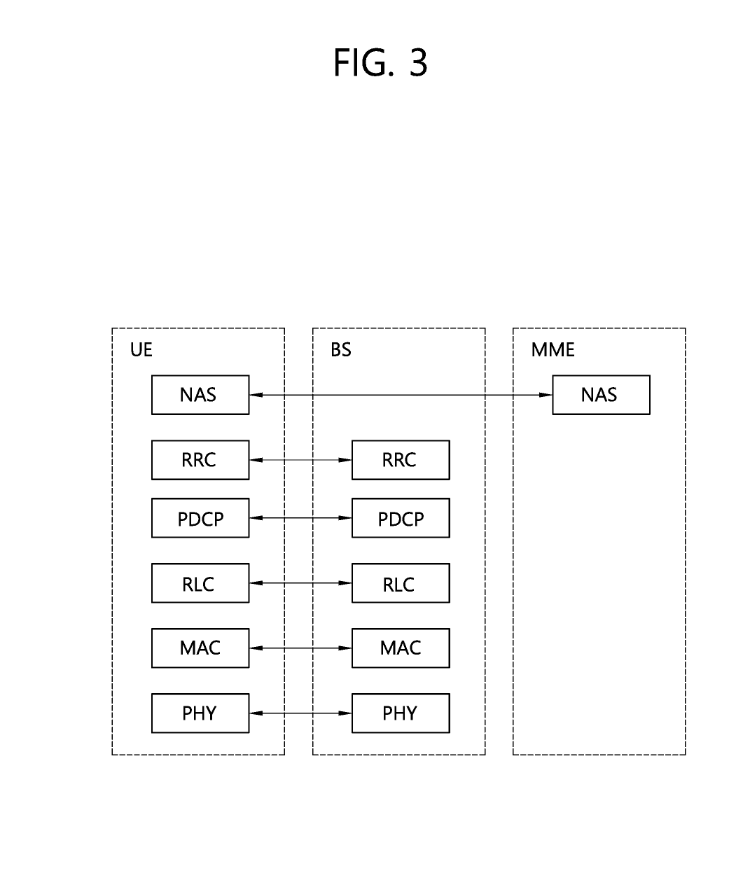

FIG. 2 is a diagram showing a wireless protocol architecture for a user plane. FIG. 3 is a diagram showing a wireless protocol architecture for a control plane. The user plane is a protocol stack for user data transmission. The control plane is a protocol stack for control signal transmission.

Referring to FIGS. 2 and 3, a PHY layer provides an upper layer with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transferred through a radio interface.

Data is moved between different PHY layers, that is, the PHY layers of a transmitter and a receiver, through a physical channel. The physical channel may be modulated according to an Orthogonal Frequency Division Multiplexing (OFDM) scheme, and use the time and frequency as radio resources.

The functions of the MAC layer include mapping between a logical channel and a transport channel and multiplexing and demultiplexing to a transport block that is provided through a physical channel on the transport channel of a MAC Service Data Unit (SDU) that belongs to a logical channel. The MAC layer provides service to a Radio Link Control (RLC) layer through the logical channel.

The functions of the RLC layer include the concatenation, segmentation, and reassembly of an RLC SDU. In order to guarantee various types of Quality of Service (QoS) required by a Radio Bearer (RB), the RLC layer provides three types of operation mode: Transparent Mode (TM), Unacknowledged Mode (UM), and Acknowledged Mode (AM). AM RLC provides error correction through an Automatic Repeat Request (ARQ).

The RRC layer is defined only on the control plane. The RRC layer is related to the configuration, reconfiguration, and release of radio bearers, and is responsible for control of logical channels, transport channels, and PHY channels. An RB means a logical route that is provided by the first layer (PHY layer) and the second layers (MAC layer, the RLC layer, and the PDCP layer) in order to transfer data between UE and a network.

The function of a Packet Data Convergence Protocol (PDCP) layer on the user plane includes the transfer of user data and header compression and ciphering. The function of the PDCP layer on the user plane further includes the transfer and encryption/integrity protection of control plane data.

What an RB is configured means a procedure of defining the characteristics of a wireless protocol layer and channels in order to provide specific service and configuring each detailed parameter and operating method. An RB can be divided into two types of a Signaling RB (SRB) and a Data RB (DRB). The SRB is used as a passage through which an RRC message is transmitted on the control plane, and the DRB is used as a passage through which user data is transmitted on the user plane.

If RRC connection is established between the RRC layer of UE and the RRC layer of an E-UTRAN, the UE is in the RRC connected state. If not, the UE is in the RRC idle state.

A downlink transport channel through which data is transmitted from a network to UE includes a broadcast channel (BCH) through which system information is transmitted and a downlink shared channel (SCH) through which user traffic or control messages are transmitted. Traffic or a control message for downlink multicast or broadcast service may be transmitted through the downlink SCH, or may be transmitted through an additional downlink multicast channel (MCH). Meanwhile, an uplink transport channel through which data is transmitted from UE to a network includes a random access channel (RACH) through which an initial control message is transmitted and an uplink shared channel (SCH) through which user traffic or control messages are transmitted.

Logical channels that are placed over the transport channel and that are mapped to the transport channel include a broadcast control channel (BCCH), a paging control channel (PCCH), a common control channel (CCCH), a multicast control channel (MCCH), and a multicast traffic channel (MTCH).

The physical channel includes several OFDM symbols in the time domain and several subcarriers in the frequency domain. One subframe includes a plurality of OFDM symbols in the time domain. An RB is a resources allocation unit, and includes a plurality of OFDM symbols and a plurality of subcarriers. Furthermore, each subframe may use specific subcarriers of specific OFDM symbols (e.g., the first OFDM symbol) of the corresponding subframe for a physical downlink control channel (PDCCH), that is, an L1/L2 control channel. A Transmission Time Interval (TTI) is a unit time for subframe transmission.

The RRC state of UE and an RRC connection method are described below.

The RRC state means whether or not the RRC layer of UE is logically connected to the RRC layer of the E-UTRAN. A case where the RRC layer of UE is logically connected to the RRC layer of the E-UTRAN is referred to as an RRC connected state. A case where the RRC layer of UE is not logically connected to the RRC layer of the E-UTRAN is referred to as an RRC idle state. The E-UTRAN may check the existence of corresponding UE in the RRC connected state in each cell because the UE has RRC connection, so the UE may be effectively controlled. In contrast, the E-UTRAN is unable to check UE in the RRC idle state, and a Core Network (CN) manages UE in the RRC idle state in each tracking area, that is, the unit of an area greater than a cell. That is, the existence or non-existence of UE in the RRC idle state is checked only for each large area. Accordingly, the UE needs to shift to the RRC connected state in order to be provided with common mobile communication service, such as voice or data.

When a user first powers UE, the UE first searches for a proper cell and remains in the RRC idle state in the corresponding cell. The UE in the RRC idle state establishes RRC connection with an E-UTRAN through an RRC connection procedure when it is necessary to set up the RRC connection, and shifts to the RRC connected state. A case where UE in the RRC idle state needs to set up RRC connection includes several cases. For example, the cases may include a need to send uplink data for a reason, such as a call attempt by a user, and to send a response message as a response to a paging message received from an E-UTRAN.

A Non-Access Stratum (NAS) layer placed over the RRC layer performs functions, such as session management and mobility management.

In the NAS layer, in order to manage the mobility of UE, two types of states: EPS Mobility Management-REGISTERED (EMM-REGISTERED) and EMM-DEREGISTERED are defined. The two states are applied to UE and the MME. UE is initially in the EMM-DEREGISTERED state. In order to access a network, the UE performs a procedure of registering it with the corresponding network through an initial attach procedure. If the attach procedure is successfully performed, the UE and the MME become the EMM-REGISTERED state.

In order to manage signaling connection between UE and the EPC, two types of states: an EPS Connection Management (ECM)-IDLE state and an ECM-CONNECTED state are defined. The two states are applied to UE and the MME. When the UE in the ECM-IDLE state establishes RRC connection with the E-UTRAN, the UE becomes the ECM-CONNECTED state. The MME in the ECM-IDLE state becomes the ECM-CONNECTED state when it establishes S1 connection with the E-UTRAN. When the UE is in the ECM-IDLE state, the E-UTRAN does not have information about the context of the UE. Accordingly, the UE in the ECM-IDLE state performs procedures related to UE-based mobility, such as cell selection or cell reselection, without a need to receive a command from a network. In contrast, when the UE is in the ECM-CONNECTED state, the mobility of the UE is managed in response to a command from a network. If the location of the UE in the ECM-IDLE state is different from a location known to the network, the UE informs the network of its corresponding location through a tracking area update procedure.

System information is described below.

System information includes essential information that needs to be known by UE in order for the UE to access a BS. Accordingly, the UE needs to have received all pieces of system information before accessing the BS, and needs to always have the up-to-date system information. Furthermore, the BS periodically transmits the system information because the system information is information that needs to be known by all UEs within one cell. The system information is divided into a Master Information Block (MIB) and a plurality of System Information Blocks (SIBs).

The MIB may include a limited number of parameters that are most essential and most frequently transmitted when other information is required to be obtained from a cell. UE first searches for an MIB after downlink synchronization. The MIB may include information, such as an SFN that supports downlink channel bandwidth, a PHICH configuration, and synchronization and operates as a timing criterion and an eNB transmit antenna configuration. The MIB may be transmitted on a broadcast channel (BCH) through broadcasting.

SystemInformationBlockType1 (SIB1) of included SIBs is included in a “SystemInformationBlockType1” message and transmitted. The remaining SIBs other than the SIB1 is included in a system information message and transmitted. To map the SIBs to the system information message may be flexibly configured by a scheduling information list parameter included in the SIB1. In this case, each of the SIBs is included in a single system information message, and only SIBs having the same scheduling requirement value (e.g. cycle) may be mapped to the same system information message. Furthermore, a SystemInformationBlockType2 (SIB2) is always mapped to a system information message corresponding to the first entry within the system information message list of a scheduling information list. A plurality of system information messages may be transmitted within the same cycle. The SIB1 and all the system information messages are transmitted on a DL-SCH.

In addition to broadcast transmission, in an E-UTRAN, the SIB1 may be dedicated-signaled in the state in which it includes a parameter configured like an existing configured value. In this case, the SIB1 may be included in an RRC connection reconfiguration message and transmitted.

The SIB1 includes information related to UE cell access, and defines the scheduling of other SIBs. The SIB1 may include information related to the PLMN identifiers of a network, tracking area code (TAC) and a cell ID, a cell barring status indicative of whether a cell is a cell on which camp-on is possible, the lowest reception level required within a cell which is used as cell reselection criterion, and the transmission time and cycle of other SIBs.

The SIB2 may include radio resource configuration information common to all pieces of UE. The SIB2 may include information related to an uplink carrier frequency and uplink channel bandwidth, an RACH configuration, a page configuration, an uplink power control configuration, a sounding reference signal configuration, a PUCCH configuration supporting ACK/NACK transmission, and a PUSCH configuration.

UE may apply a procedure for obtaining system information and detecting a change of system information to a primary cell (PCell) only. In a secondary cell (SCell), when a corresponding SCell is added, an E-UTRAN may provide all of pieces of system information related to an RRC connection state operation through dedicated signaling. When system information related to a configured SCell is changed, an E-UTRAN may release an SCell that is taken into consideration and subsequently add the changed system information. This may be performed along with a single RRC connection reconfiguration message. An E-UTRAN may configure parameter values different from a value broadcasted within an SCell that has been taken into consideration through dedicated signaling.

UE needs to guarantee the validity of a specific type of system information, and such system information is called required system information. The required system information may be defined as follows.
If UE is an RRC idle state: The UE needs to be guaranteed so that it has the valid versions of the MIB and the SIB1 in addition to the SIB2 to SIB8. This may comply with the support of a radio access technology (RAT) that is taken into consideration.
If UE is an RRC connection state: The UE needs to be guaranteed so that it has the valid versions of the MIB, the SIB1, and the SIB2.

In general, the validity of system information may be guaranteed up to a maximum of 3 hours after the system information is obtained.

In general, service that is provided to UE by a network may be classified into three types as follows. Furthermore, the UE differently recognizes the type of cell depending on what service may be provided to the UE. In the following description, a service type is first described, and the type of cell is described.

1) Limited service: this service provides emergency calls and an Earthquake and Tsunami Warning System (ETWS), and may be provided by an acceptable cell.

2) Suitable service: this service means public service for common uses, and may be provided by a suitable cell (or a normal cell).

3) Operator service: this service means service for communication network operators. This cell may be used by only communication network operators, but may not be used by common users.

In relation to a service type provided by a cell, the type of cell may be classified as follows.

1) An acceptable cell: this cell is a cell from which UE may be provided with limited service. This cell is a cell that has not been barred from a viewpoint of corresponding UE and that satisfies the cell selection criterion of the UE.

2) A suitable cell: this cell is a cell from which UE may be provided with suitable service. This cell satisfies the conditions of an acceptable cell and also satisfies additional conditions. The additional conditions include that the suitable cell needs to belong to a Public Land Mobile Network (PLMN) to which corresponding UE may access and that the suitable cell is a cell on which the execution of a tracking area update procedure by the UE is not barred. If a corresponding cell is a CSG cell, the cell needs to be a cell to which UE may access as a member of the CSG.

3) A barred cell: this cell is a cell that broadcasts information indicative of a barred cell through system information.

4) A reserved cell: this cell is a cell that broadcasts information indicative of a reserved cell through system information.

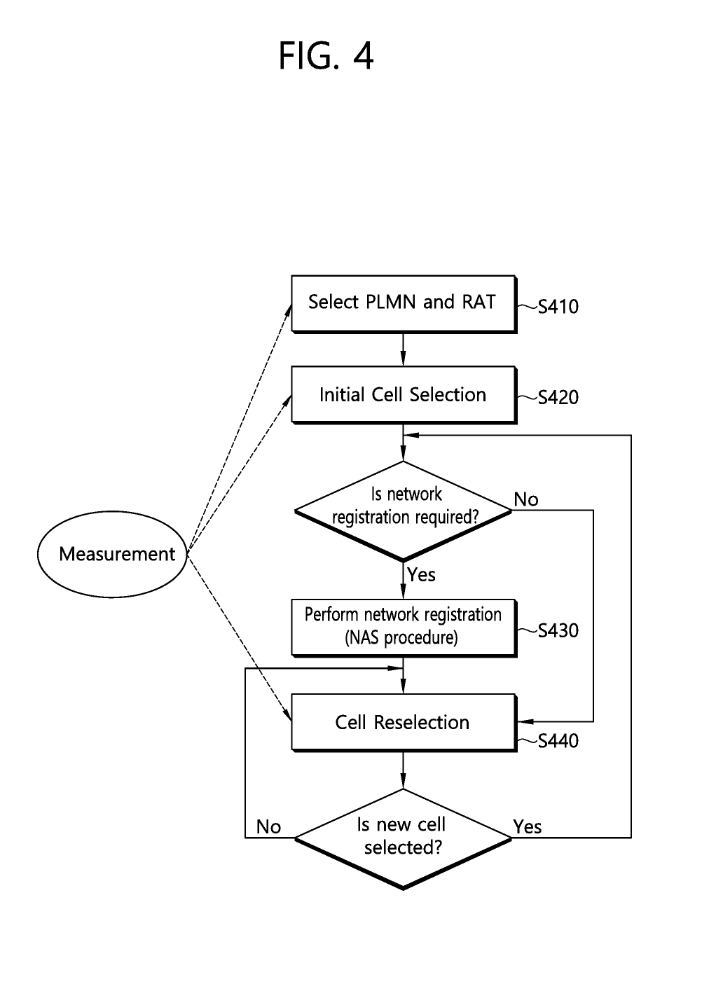

FIG. 4 is a flowchart illustrating the operation of UE in the RRC idle state. FIG. 4 illustrates a procedure in which UE that is initially powered on experiences a cell selection procedure, registers it with a network, and then performs cell reselection if necessary.

Referring to FIG. 4, the UE selects Radio Access Technology (RAT) in which the UE communicates with a Public Land Mobile Network (PLMN), that is, a network from which the UE is provided with service (S410). Information about the PLMN and the RAT may be selected by the user of the UE, and the information stored in a Universal Subscriber Identity Module (USIM) may be used.

The UE selects a cell that has the greatest value and that belongs to cells having measured BS and signal intensity or quality greater than a specific value (cell selection) (S420). In this case, the UE that is powered off performs cell selection, which may be called initial cell selection. A cell selection procedure is described later in detail. After the cell selection, the UE receives system information periodically by the BS. The specific value refers to a value that is defined in a system in order for the quality of a physical signal in data transmission/reception to be guaranteed. Accordingly, the specific value may differ depending on applied RAT.

If network registration is necessary, the UE performs a network registration procedure (S430). The UE registers its information (e.g., an IMSI) with the network in order to receive service (e.g., paging) from the network. The UE does not register it with a network whenever it selects a cell, but registers it with a network when information about the network (e.g., a Tracking Area Identity (TAI)) included in system information is different from information about the network that is known to the UE.

The UE performs cell reselection based on a service environment provided by the cell or the environment of the UE (S440). If the value of the intensity or quality of a signal measured based on a BS from which the UE is provided with service is lower than that measured based on a BS of a neighboring cell, the UE selects a cell that belongs to other cells and that provides better signal characteristics than the cell of the BS that is accessed by the UE. This procedure is called cell reselection differently from the initial cell selection of the No. 2 procedure. In this case, temporal restriction conditions are placed in order for a cell to be frequently reselected in response to a change of signal characteristic. A cell reselection procedure is described later in detail.

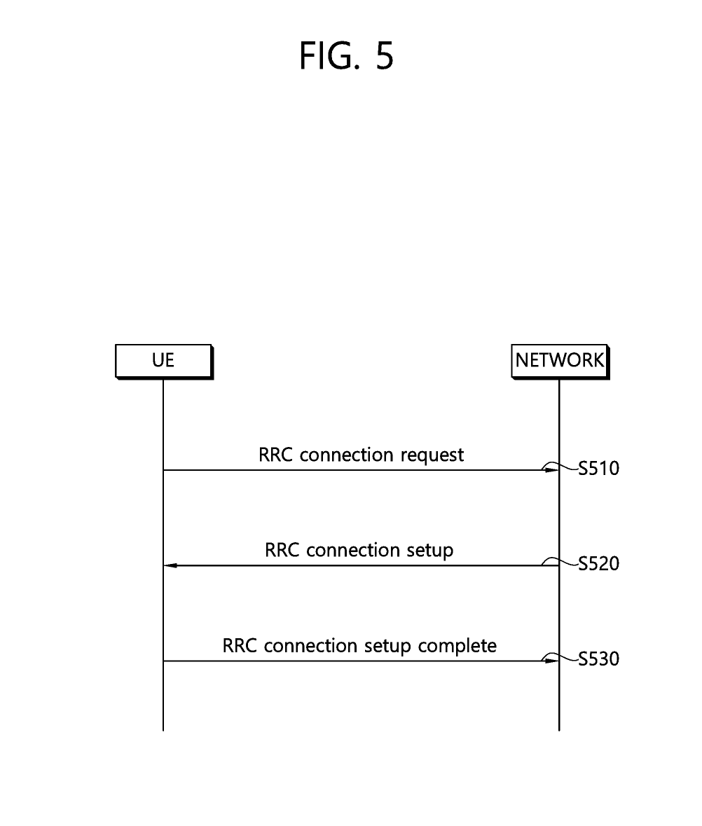

FIG. 5 is a flowchart illustrating a procedure of establishing RRC connection.

UE sends an RRC connection request message that requests RRC connection to a network (S510). The network sends an RRC connection establishment message as a response to the RRC connection request (S520). After receiving the RRC connection establishment message, the UE enters RRC connected mode.

The UE sends an RRC connection establishment complete message used to check the successful completion of the RRC connection to the network (S530).

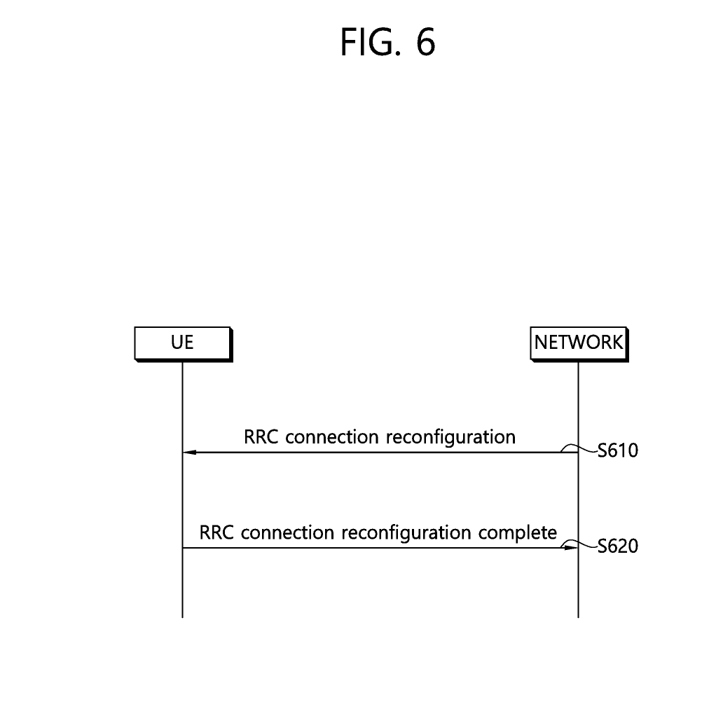

FIG. 6 is a flowchart illustrating an RRC connection reconfiguration procedure. An RRC connection reconfiguration is used to modify RRC connection. This is used to establish/modify/release RBs, perform handover, and set up/modify/release measurements.

A network sends an RRC connection reconfiguration message for modifying RRC connection to UE (S610). As a response to the RRC connection reconfiguration message, the UE sends an RRC connection reconfiguration complete message used to check the successful completion of the RRC connection reconfiguration to the network (S620).

Hereinafter, a public land mobile network (PLMN) is described.

The PLMN is a network which is disposed and operated by a mobile network operator. Each mobile network operator operates one or more PLMNs. Each PLMN may be identified by a Mobile Country Code (MCC) and a Mobile Network Code (MNC). PLMN information of a cell is included in system information and broadcasted.

In PLMN selection, cell selection, and cell reselection, various types of PLMNs may be considered by the terminal.

Home PLMN (HPLMN): PLMN having MCC and MNC matching with MCC and MNC of a terminal IMSI.

Equivalent HPLMN (EHPLMN): PLMN serving as an equivalent of an HPLMN.

Registered PLMN (RPLMN): PLMN successfully finishing location registration.

Equivalent PLMN (EPLMN): PLMN serving as an equivalent of an RPLMN.

Each mobile service consumer subscribes in the HPLMN. When a general service is provided to the terminal through the HPLMN or the EHPLMN, the terminal is not in a roaming state. Meanwhile, when the service is provided to the terminal through a PLMN except for the HPLMN/EHPLMN, the terminal is in the roaming state. In this case, the PLMN refers to a Visited PLMN (VPLMN).

When UE is initially powered on, the UE searches for available Public Land Mobile Networks (PLMNs) and selects a proper PLMN from which the UE is able to be provided with service. The PLMN is a network that is deployed or operated by a mobile network operator. Each mobile network operator operates one or more PLMNs. Each PLMN may be identified by Mobile Country Code (MCC) and Mobile Network Code (MNC). Information about the PLMN of a cell is included in system information and broadcasted. The UE attempts to register it with the selected PLMN. If registration is successful, the selected PLMN becomes a Registered PLMN (RPLMN). The network may signalize a PLMN list to the UE. In this case, PLMNs included in the PLMN list may be considered to be PLMNs, such as RPLMNs. The UE registered with the network needs to be able to be always reachable by the network. If the UE is in the ECM-CONNECTED state (identically the RRC connection state), the network recognizes that the UE is being provided with service. If the UE is in the ECM-IDLE state (identically the RRC idle state), however, the situation of the UE is not valid in an eNB, but is stored in the MME. In such a case, only the MME is informed of the location of the UE in the ECM-IDLE state through the granularity of the list of Tracking Areas (TAs). A single TA is identified by a Tracking Area Identity (TAI) formed of the identifier of a PLMN to which the TA belongs and Tracking Area Code (TAC) that uniquely expresses the TA within the PLMN.

Thereafter, the UE selects a cell that belongs to cells provided by the selected PLMN and that has signal quality and characteristics on which the UE is able to be provided with proper service.

The following is a detailed description of a procedure of selecting a cell by a terminal.

When power is turned-on or the terminal is located in a cell, the terminal performs procedures for receiving a service by selecting/reselecting a suitable quality cell.

A terminal in an RRC idle state should prepare to receive a service through the cell by always selecting a suitable quality cell. For example, a terminal where power is turned-on just before should select the suitable quality cell to be registered in a network. If the terminal in an RRC connection state enters in an RRC idle state, the terminal should selects a cell for stay in the RRC idle state. In this way, a procedure of selecting a cell satisfying a certain condition by the terminal in order to be in a service idle state such as the RRC idle state refers to cell selection. Since the cell selection is performed in a state that a cell in the RRC idle state is not currently determined, it is important to select the cell as rapid as possible. Accordingly, if the cell provides a wireless signal quality of a predetermined level or greater, although the cell does not provide the best wireless signal quality, the cell may be selected during a cell selection procedure of the terminal.

A method and a procedure of selecting a cell by a terminal in a 3GPP LTE is described with reference to 3GPP TS 36.304 V8.5.0 (2009-03) “User Equipment (UE) procedures in idle mode (Release 8)”.

A cell selection procedure is basically divided into two types.

The first is an initial cell selection procedure. In this procedure, UE does not have preliminary information about a wireless channel. Accordingly, the UE searches for all wireless channels in order to find out a proper cell. The UE searches for the strongest cell in each channel Thereafter, if the UE has only to search for a suitable cell that satisfies a cell selection criterion, the UE selects the corresponding cell.

Next, the UE may select the cell using stored information or using information broadcasted by the cell. Accordingly, cell selection may be fast compared to an initial cell selection procedure. If the UE has only to search for a cell that satisfies the cell selection criterion, the UE selects the corresponding cell. If a suitable cell that satisfies the cell selection criterion is not retrieved though such a procedure, the UE performs an initial cell selection procedure.

A cell selection criterion may be defined as in Equation 1 below.

Srxlev>0 AND Squal>0. [Equation 1]
where:
Srxlev=Qᵣₓₗₑᵥₘₑₐₛ−(Qᵣₓₗₑᵥₘᵢₙ+Q_{rxlevminoffset})−P_{compensation},
Squal=Q_{qualmeas}−(Q_{qualmin}+Q_{qualoffset})

In this case, in Equation 1, the variables may be defined as in Table 1 below.

TABLE 1

| | |
|---|---|
| Srxlev | Cell selection RX level value (dB) |
| Squal | Cell selection quality value (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm) |
| Q_{qualmin} | Minimum required quality level in the cell (dB) |
| Q_{rxlevminoffset} | Offset to the signalled Qᵣₓₗₑᵥₘᵢₙ taken into account in |
| | the Srxlev evaluation as a result of a periodic search |
| | for a higher priority PLMN while camped normally in |
| | a VPLMN |
| Q_{qualminoffset} | Offset to the signalled Q_{qualmin} taken into account in |
| | the Squal evaluation as a result of a periodic search |
| | for a higher priority PLMN while camped normally in |
| | a VPLMN |
| Pcompensation | max(P_{EMAX} − P_{PowerClass}, 0) (dB) |
| P_{EMAX} | Maximum TX power level an UE may use when |
| | transmitting on the uplink in the cell (dBm) |
| | defined as P_{EMAX} in [TS 36.101] |
| P_{PowerClass} | Maximum RF output power of the UE (dBm) according |
| | to the UE power class as defined in [TS 36.101] |

Qrxlevminoffset and Qqualminoffset, that is, signaled values, are the results of periodic discovery for a PLMN having higher priority while UE camps on a normal cell within a VPLMN, and may be applied only when cell selection is evaluated. As described above, during the periodic discovery of a PLMN having higher priority, UE may perform cell selection evaluation using parameter values stored from another cell of the PLMN having such higher priority.

After UE selects any cell through a cell selection procedure, the intensity or quality of a signal between the UE and a BS may be changed due to the mobility of the UE or a change of a radio environment. Accordingly, if the quality of the selected cell is changed, the UE may select another cell providing better quality.

After the UE selects a specific cell through the cell selection procedure, the intensity or quality of a signal between the UE and a BS may be changed due to a change in the mobility or wireless environment of the UE. Accordingly, if the quality of the selected cell is deteriorated, the UE may select another cell that provides better quality. If a cell is reselected as described above, the UE selects a cell that provides better signal quality than the currently selected cell. Such a procedure is called cell reselection. In general, a basic object of the cell reselection procedure is to select a cell that provides UE with the best quality from a viewpoint of the quality of a radio signal.

In addition to the viewpoint of the quality of a radio signal, a network may determine priority corresponding to each frequency, and may inform the UE of the determined priorities. The UE that has received the priorities preferentially takes into consideration the priorities in a cell reselection procedure compared to a radio signal quality criterion.

As described above, there is a method of selecting or reselecting a cell according to the signal characteristics of a wireless environment. In selecting a cell for reselection when a cell is reselected, the following cell reselection methods may be present according to the RAT and frequency characteristics of the cell.
Intra-frequency cell reselection: UE reselects a cell having the same center frequency as that of RAT, such as a cell on which the UE camps on.
Inter-frequency cell reselection: UE reselects a cell having a different center frequency from that of RAT, such as a cell on which the UE camps on
Inter-RAT cell reselection: UE reselects a cell that uses RAT different from RAT on which the UE camps

The principle of a cell reselection procedure is as follows.

First, UE measures the quality of a serving cell and neighbor cells for cell reselection.

Second, cell reselection is performed based on a cell reselection criterion. The cell reselection criterion has the following characteristics in relation to the measurements of a serving cell and neighbor cells.

Intra-frequency cell reselection is basically based on ranking. Ranking is a task for defining a criterion value for evaluating cell reselection and numbering cells using criterion values according to the size of the criterion values. A cell having the best criterion is commonly called the best-ranked cell. The cell criterion value is based on the value of a corresponding cell measured by UE, and may be a value to which a frequency offset or cell offset has been applied, if necessary.

Inter-frequency cell reselection is based on frequency priority provided by a network. UE attempts to camp on a frequency having the highest frequency priority. A network may provide frequency priority that will be applied by UEs within a cell in common through broadcasting signaling, or may provide frequency-specific priority to each UE through UE-dedicated signaling. A cell reselection priority provided through broadcast signaling may refer to a common priority. A cell reselection priority for each terminal set by a network may refer to a dedicated priority. If receiving the dedicated priority, the terminal may receive a valid time associated with the dedicated priority together. If receiving the dedicated priority, the terminal starts a validity timer set as the received valid time together therewith. While the valid timer is operated, the terminal applies the dedicated priority in the RRC idle mode. If the valid timer is expired, the terminal discards the dedicated priority and again applies the common priority.

For the inter-frequency cell reselection, a network may provide UE with a parameter (e.g., a frequency-specific offset) used in cell reselection for each frequency. For the intra-frequency cell reselection or the inter-frequency cell reselection, a network may provide UE with a Neighboring Cell List (NCL) used in cell reselection. The NCL includes a cell-specific parameter (e.g., a cell-specific offset) used in cell reselection. For the intra-frequency or inter-frequency cell reselection, a network may provide UE with a cell reselection black list used in cell reselection.

The UE does not perform cell reselection on a cell included in the black list.

Ranking performed in a cell reselection evaluation procedure is described below.

A ranking criterion used to give the priority of a cell is defined as in Equation 2.

Rₛ=Q_{meas,s}+Q_{hyst},Rₙ=Q_{meas,n}−Q_{offset} [Equation 2]

In Equation 2, Rs is the ranking criterion of a serving cell on which UE now camps, Rn is the ranking criterion of a neighboring cell, Qmeas,s is the quality value of the serving cell measured by the UE, Qmeas,n is the quality value of the neighboring cell measured by the UE, Qhyst is a hysteresis value for ranking, and Qoffset is an offset between the two cells.

In Intra-frequency, if UE receives an offset “Qoffsets,n” between a serving cell and a neighbor cell, Qoffset=Qoffsets,n. If UE does not Qoffsets,n, Qoffset=0.

In Inter-frequency, if UE receives an offset “Qoffsets,n” for a corresponding cell, Qoffset=Qoffsets,n+Qfrequency. If UE does not receive “Qoffsets,n”, Qoffset=Qfrequency.

If the ranking criterion Rs of a serving cell and the ranking criterion Rn of a neighbor cell are changed in a similar state, ranking priority is frequency changed as a result of the change, and UE may alternately reselect the twos. Qhyst is a parameter that gives hysteresis to cell reselection so that UE is prevented from to alternately reselecting two cells.

UE measures RS of a serving cell and Rn of a neighbor cell according to the above equation, considers a cell having the greatest ranking criterion value to be the best-ranked cell, and reselects the cell.

In accordance with the criterion, it may be checked that the quality of a cell is the most important criterion in cell reselection. If a reselected cell is not a suitable cell, UE excludes a corresponding frequency or a corresponding cell from the subject of cell reselection.

Hereinafter, radio link failure (RLF) will be described.

UE continues to perform measurements in order to maintain the quality of a radio link with a serving cell from which the UE receives service. The UE determines whether or not communication is impossible in a current situation due to the deterioration of the quality of the radio link with the serving cell. If communication is almost impossible because the quality of the serving cell is too low, the UE determines the current situation to be an RLF.

If the RLF is determined, the UE abandons maintaining communication with the current serving cell, selects a new cell through cell selection (or cell reselection) procedure, and attempts RRC connection re-establishment with the new cell.

In the specification of 3GPP LTE, the following examples are taken as cases where normal communication is impossible.
A case where UE determines that there is a serious problem in the quality of a downlink communication link (a case where the quality of a PCell is determined to be low while performing RLM) based on the radio quality measured results of the PHY layer of the UE
A case where uplink transmission is problematic because a random access procedure continues to fail in the MAC sublayer.
A case where uplink transmission is problematic because uplink data transmission continues to fail in the RLC sublayer.
A case where handover is determined to have failed.
A case where a message received by UE does not pass through an integrity check.

An RRC connection re-establishment procedure is described in more detail below.

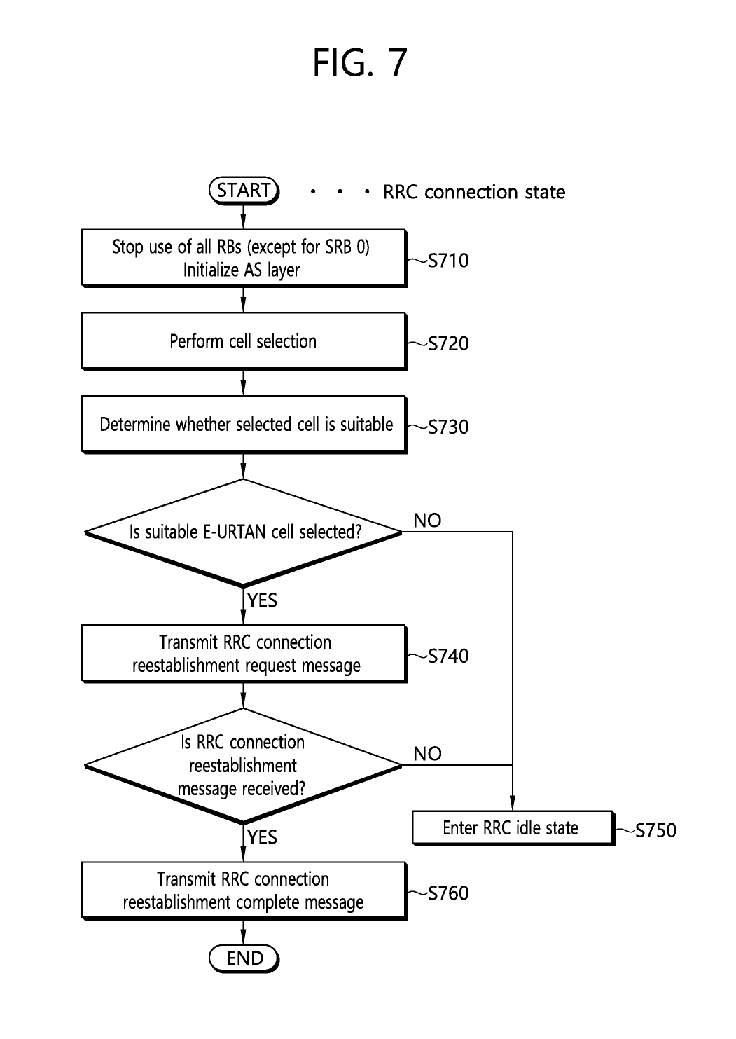

FIG. 7 is a diagram illustrating an RRC connection re-establishment procedure.

Referring to FIG. 7, UE stops using all the radio bearers that have been configured other than a Signaling Radio Bearer (SRB) #0, and initializes a variety of kinds of sublayers of an Access Stratum (AS) (S710). Furthermore, the UE configures each sublayer and the PHY layer as a default configuration. In this procedure, the UE maintains the RRC connection state.

The UE performs a cell selection procedure for performing an RRC connection reconfiguration procedure (S720). The cell selection procedure of the RRC connection re-establishment procedure may be performed in the same manner as the cell selection procedure that is performed by the UE in the RRC idle state, although the UE maintains the RRC connection state.

After performing the cell selection procedure, the UE determines whether or not a corresponding cell is a suitable cell by checking the system information of the corresponding cell (S730). If the selected cell is determined to be a suitable E-UTRAN cell, the UE sends an RRC connection re-establishment request message to the corresponding cell (S740).

Meanwhile, if the selected cell is determined to be a cell that uses RAT different from that of the E-UTRAN through the cell selection procedure for performing the RRC connection re-establishment procedure, the UE stops the RRC connection re-establishment procedure and enters the RRC idle state (S750).

The UE may be implemented to finish checking whether the selected cell is a suitable cell through the cell selection procedure and the reception of the system information of the selected cell. To this end, the UE may drive a timer when the RRC connection re-establishment procedure is started. The timer may be stopped if it is determined that the UE has selected a suitable cell. If the timer expires, the UE may consider that the RRC connection re-establishment procedure has failed, and may enter the RRC idle state. Such a timer is hereinafter called an RLF timer. In LTE spec TS 36.331, a timer named “T311” may be used as an RLF timer. The UE may obtain the set value of the timer from the system information of the serving cell.

If an RRC connection re-establishment request message is received from the UE and the request is accepted, a cell sends an RRC connection re-establishment message to the UE.

The UE that has received the RRC connection re-establishment message from the cell reconfigures a PDCP sublayer and an RLC sublayer with an SRB1. Furthermore, the UE calculates various key values related to security setting, and reconfigures a PDCP sublayer responsible for security as the newly calculated security key values. Accordingly, the SRB1 between the UE and the cell is open, and the UE and the cell may exchange RRC control messages. The UE completes the restart of the SRB1, and sends an RRC connection re-establishment complete message indicative of that the RRC connection re-establishment procedure has been completed to the cell (S760).

In contrast, if the RRC connection re-establishment request message is received from the UE and the request is not accepted, the cell sends an RRC connection re-establishment reject message to the UE.

If the RRC connection re-establishment procedure is successfully performed, the cell and the UE perform an RRC connection reconfiguration procedure. Accordingly, the UE recovers the state prior to the execution of the RRC connection re-establishment procedure, and the continuity of service is guaranteed to the upmost.

Subsequently, an RLF report is described.

When an RLF or handover failure arises, the UE reports these failure events to a network in order to support Mobility Robustness Optimization (MRO).

After RRC connection re-establishment, the UE may provide an RLF report to the eNB. A radio measurement included in the RLF report may be used as a potential reason for failure in order to identify coverage problems. This information may be used to exclude such events from MRO evaluation on connection failure by intra-LTE mobility and to borrow the events as inputs for other algorithms.

When RRC connection re-establishment fails or the UE is unable to perform RRC connection re-establishment, the UE may perform reconnection in the idle mode and may generate a valid RLF report for the eNB. To this end, the UE may store information on the latest RLF or handover failure and may indicate the validity of the RLF report to an LTE cell in every RRC connection (re)establishment and handover until the network imports the RLF report or for 48 hours after the detection of the RLF or handover failure.

The UE maintains the information during state transition and RAT change, returns to the LTE RAT, and indicates the validity of the RLF report.

In an RRC connection configuration procedure, the validity of the RLF report indicates that the UE is interrupted by a connection failure and the RLF report is not yet transmitted to the network due to this failure. The RLF report from the UE includes information below.
E-CGI of the last cell that has served a UE (in the case of RLF) or a target of handover. If no E-CGI is known, PCI and frequency information are used instead.
E-CGI of a cell with which the UE attempts reestablishment.
E-CGI of a cell that serves a UE when the last handover is initialized, for example, when the receives message 7 (RRC connection reconfiguration).
Duration from the initialization of the last handover to connection failure.
Information indicating whether connection failure is caused by an RLF or handover failure.
Radio measurements.
Location of failure.

The eNB, which has received an RLF from the UE, may forward the report to an eNB which has served the UE before the reported connection failure. Radio measurements included in the RLF report are potential reasons for the RLF and may be used to identify coverage issues. This information may be used to exclude such events from MRO evaluation on connection failure by intra-LTE mobility and to resend these events as inputs for other algorithms.

Hereinafter, measurement and a measurement report are described.

In a mobile communication system, it is essential to support the mobility of a UE. Thus, the UE continuously measures the quality of a serving cell that currently provides a service and the quality of a neighboring cell. The UE reports a measurement result to a network at an appropriate time, and the network provides the UE with optimal mobility through a handover or the like. Measurement for such a purpose is generally called radio resource management (RRM) measurement.

In addition to the purpose of supporting mobility, the UE may perform measurement for a specific purpose set by the network and reports a measurement result to the network in order to provide useful information for a network operator to manage the network. For example, the UE receives broadcast information on a specific cell determined by the network. The UE may report, to the serving cell, a cell identity of the specific cell (also referred to as a global cell identity), identification information on a location of the specific cell (for example, a tracking area code), and/or extra cell information (for example, indicating whether the cell is a member of a closed subscriber group (CSG) cell).

When it is identified through measurement that the quality of a specific area is very poor, a moving UE may report location information on poor-quality cells and a measurement result to the network. The network may promote the optimization of the network based on reports on measurement results from UEs assisting the network in management.

In a mobile communication system with a frequency reuse factor of 1, mobility is mostly realized between different cells in the same frequency band. Thus, to effectively guarantee the mobility of a UE, the UE needs to properly measure qualities and cell information on neighboring cells having the same center frequency as that of the serving cell. Measurement of a cell having the same center frequency as that of a serving cell is called intra-frequency measurement. The UE performs intra-frequency measurement and reports a measurement result to the network at an appropriate time to achieve the purpose of the measurement result.

A mobile network operator may manage a network using a plurality of frequency bands. When a service of a communication system is provided through a plurality of frequency bands, a UE needs to properly measure qualities and cell information on neighboring cells having a different center frequency from that of a serving cell in order to guarantee the optimal mobility of the UE. Measurement of a cell having a different center frequency from that of a serving cell is called inter-frequency measurement. The UE may need to perform inter-frequency measurement and to report a measurement result to the network at an appropriate time.

When a UE supports measurement of a heterogeneous network, the UE may perform measurement of a cell in a heterogeneous network according to a configuration by a BS. Measurement of a heterogeneous network is called inter-Radio Access Technology (RAT) measurement. For example, an RAT may include a UMTS Terrestrial Radio Access Network (UTRAN) and a GSM EDGE Radio Access Network (GERAN) according to the 3GPP standards, and may also include a CDMA 2000 system according to the 3GPP2 standards.

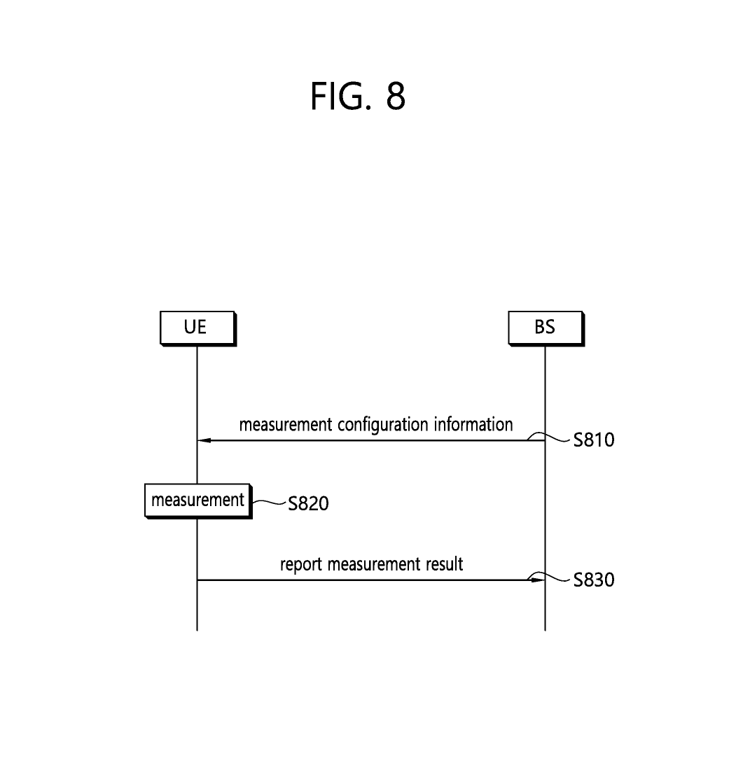

FIG. 8 is a flowchart illustrating a method for performing measurement.

A UE receives measurement configuration information from a BS (S810). A message including measurement configuration information is referred to as a measurement configuration message. The UE performs measurement based on the measurement configuration information (S820). When a measurement result satisfies a report condition in the measurement configuration information, the UE reports the measurement result to the BS (S830). A message including a measurement result is referred to as a measurement report message.

The measurement configuration information may include information as follows.

(1) Measurement object information: Information on an object of measurement by a UE. A measurement object includes any one of an intra-frequency measurement object as an object of intra-measurement, an inter-frequency measurement object as an object of inter-measurement, and an inter-RAT measurement object as an object of inter-RAT measurement. For example, an intra-frequency measurement object may refer to a neighboring cell having the same frequency band as a serving cell, an inter-frequency measurement object may refer to a neighboring cell having a different frequency band from the serving cell, and an inter-RAT measurement object may refer to a neighboring cell of a different RAT from an RAT of the serving cell.

(2) Reporting configuration information: Information on a report condition and a report type regarding when a UE reports a measurement result. A report condition may include information on an event triggering the report of a measurement result or a report period. A report type is information on a type in which a measurement result is configured.

(3) Measurement identity (ID) information: Information on a measurement ID that associates a measurement object and a reporting configuration, which allows a UE to determine a measurement object and when and in which type a measurement result is reported. Each measurement ID associates one measurement object and one reporting configuration. Setting a plurality of measurement IDs makes it possible not only to associate one or more reporting configurations with the same measurement object but also to associate one or more measurement objects with the same reporting configuration. A measurement ID may be used as a reference number in a measurement report. Measurement ID information may be included in a measurement report message to indicate which measurement object a measurement result is about and by which report condition a measurement report occurs.

(4) Quantity configuration information: Quantity configuration information defines measurement quantity and defines associated filtering used for the evaluation of all events and the related report of measurement types thereof. One filter may be set by measurement quantity.

(5) Measurement gap information: Information on a measurement gap that is an interval used for a UE to perform only measurement without considering data transmission with a serving cell as downlink transmission or uplink transmission is not scheduled.

In order to perform a measurement procedure, the UE has a measurement object list, a measurement reporting configuration list, and a measurement ID list.

In 3GPP LTE, a BS may set only one measurement object in one frequency band for a UE. Measurement report triggering events listed in the following table are defined in section 5.5.4 in 3GPP TS 36.331 V8.5.0 (2009-03) “Evolved Universal Terrestrial Radio Access (E-UTRA) Radio Resource Control (RRC); Protocol specification (Release 8).”

TABLE 2

| Event | Reporting condition |
|---|---|
| Event A1 | Serving becomes better than threshold |
| Event A2 | Serving becomes worse than threshold |
| Event A3 | Neighbor becomes offset better than serving |
| Event A4 | Neighbor becomes better than threshold |
| Event A5 | Serving becomes worse than threshold and neighbor |
| | becomes better than threshold2 |
| Event B1 | Inter RAT neighbor becomes better than threshold |
| Event B2 | Serving becomes worse than threshold1 and inter RAT |
| | neighbor becomes better than threshold2 |

When a measurement result by the UE satisfies a set event, the UE transmits a measurement report message to the BS.

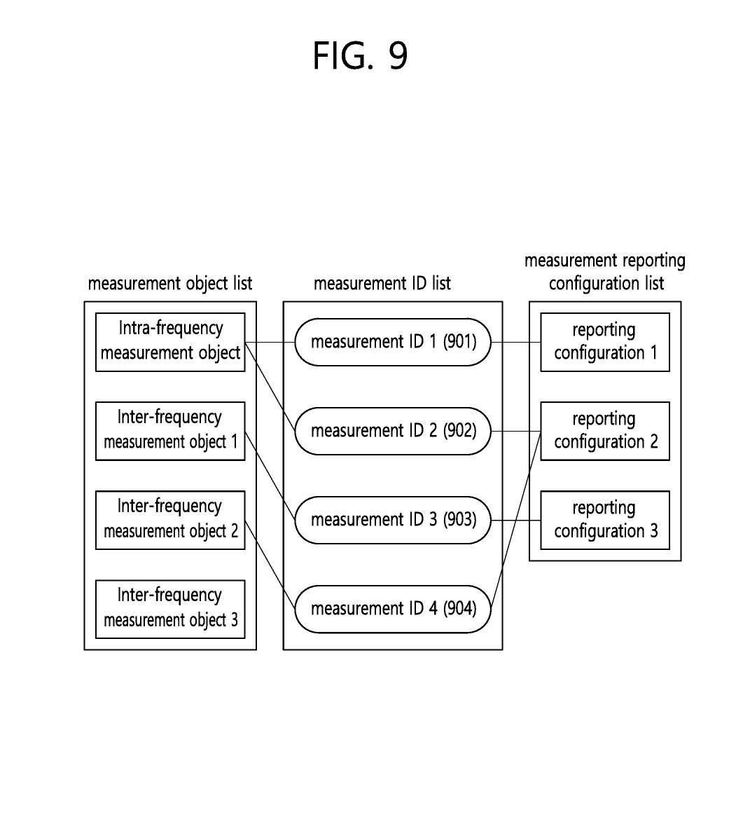

FIG. 9 illustrates an example of a measurement configuration set for a UE.

First, measurement ID 1 901 connects an intra-frequency measurement object and reporting configuration 1. The UE performs intra-frequency measurement, and reporting configuration 1 is used to determine a criterion for a measurement result report and a report type.

Measurement ID 2 902 is connected with an intra-frequency measurement object, like measurement ID 1 901, but connects the intra-frequency measurement object with reporting configuration 2. The UE performs measurement, and reporting configuration 2 is used to determine a criterion for a measurement result report and a report type.

When a measurement result relating to the intra-frequency measurement object satisfies either one of reporting configuration 1 and reporting configuration 2 based on measurement ID 1 901 and measurement ID 2 902, the UE transmits the measurement result.

Measurement ID 3 903 connects inter-frequency measurement object 1 and reporting configuration 3. When a measurement result relating to inter-frequency measurement object 1 satisfies a report condition included in reporting configuration 1, the UE reports the measurement result.

Measurement ID 4 904 connects inter-frequency measurement object 2 and reporting configuration 2. When a measurement result relating to inter-frequency measurement object 2 satisfies a report condition included in reporting configuration 2, the UE reports the measurement result.

Meanwhile, a measurement object, a reporting configuration, and/or a measurement ID may be added, changed, and/or deleted, which may be indicated by the BS sending a new measurement configuration message or measurement configuration change message to the UE.

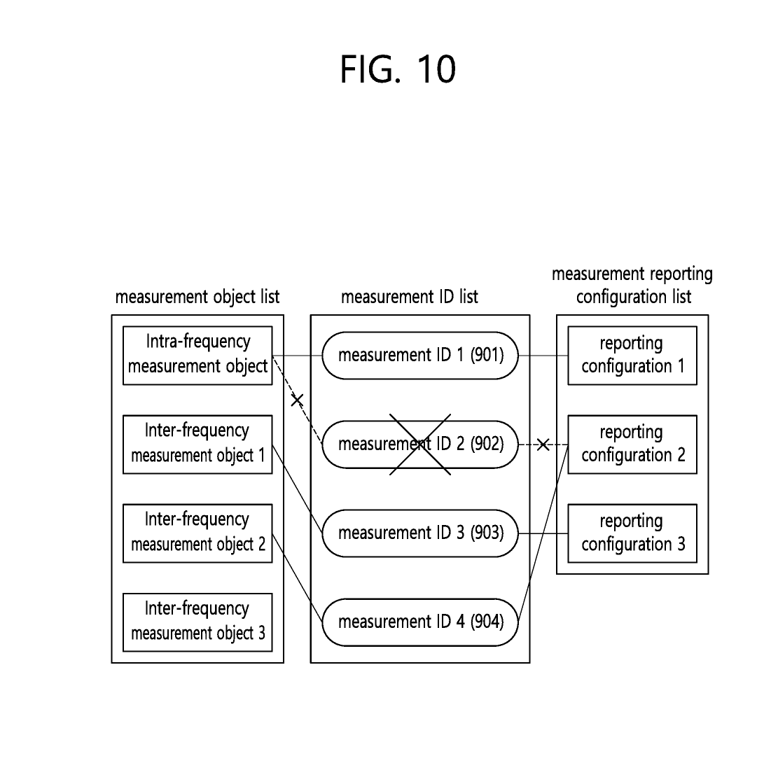

FIG. 10 illustrates an example of deleting a measurement ID. When measurement ID 2 902 is deleted, measurement of a measurement object associated with measurement ID 2 902 is stopped and no measurement report is transmitted. The measurement object or a reporting configuration associated with the deleted measurement ID may not be changed.

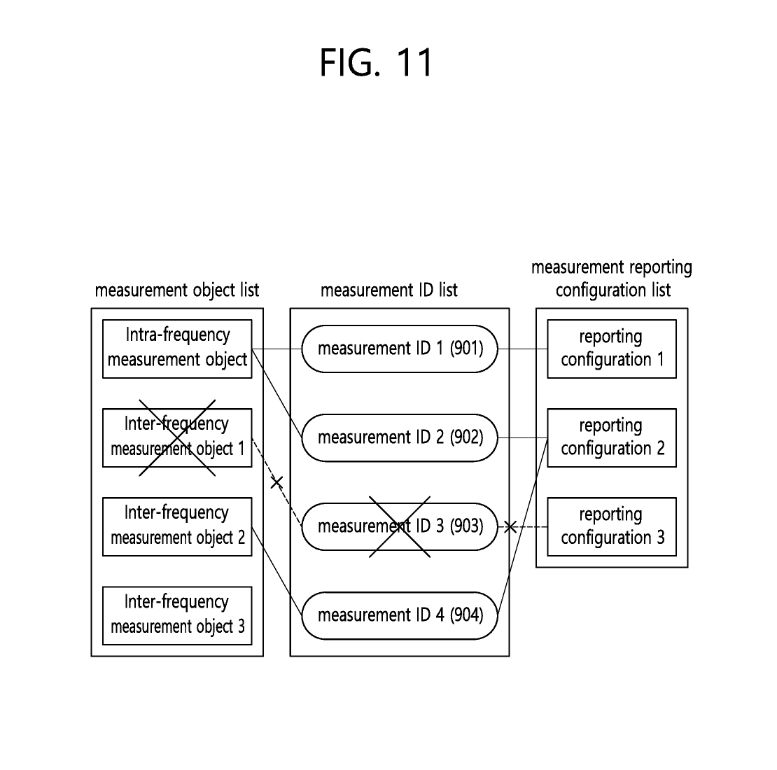

FIG. 11 illustrates an example of deleting a measurement object. When inter-frequency measurement object 1 is deleted, the UE also deletes associated measurement ID 3 903. Measurement of inter-frequency measurement object 1 is stopped, and no measurement repot is transmitted. However, a reporting configuration associated with deleted inter-frequency measurement object 1 may not be changed or deleted.

When a reporting configuration is deleted, the UE also deletes an associated measurement ID. The UE stops measurement of a measurement object associated with the associated measurement ID. However, the measurement object associated with the deleted reporting configuration may not be changed or deleted.

A measurement report may include a measurement ID, a measured quality of a serving cell, and a measurement result of a neighboring cell. A measurement ID is used to identify a measurement object about which a measurement report is triggered. A measurement result of a neighboring cell may include a cell ID and measured quality of the neighboring cell. Measured quality may include at least one of Reference Signal Received Power ((RSRP) and Reference Signal Received Quality (RSRQ).

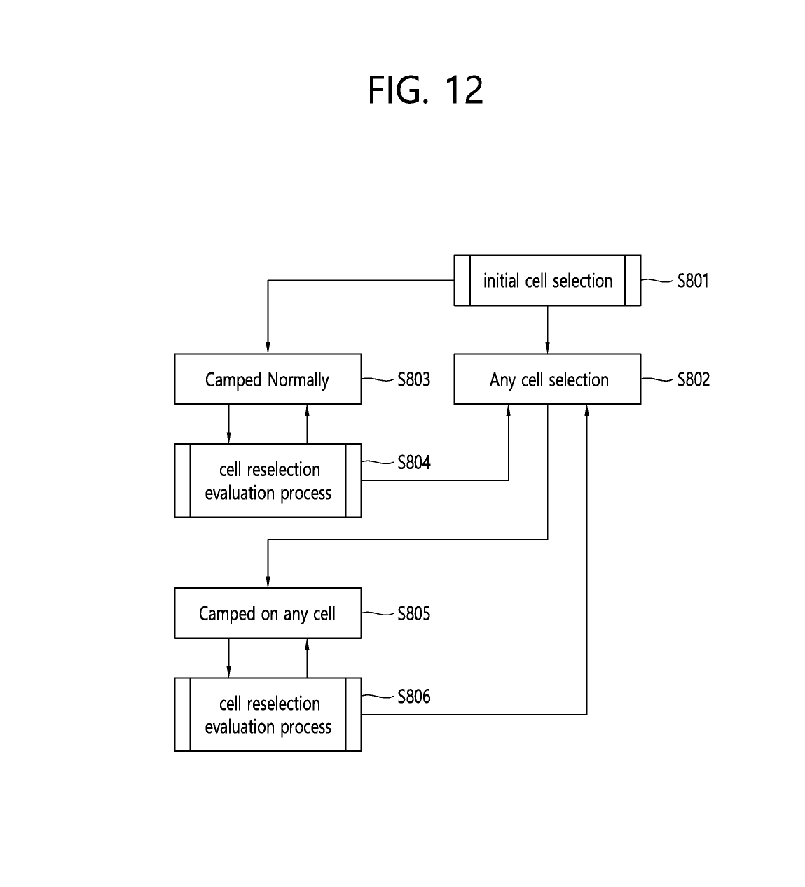

FIG. 12 illustrates sub-states that a UE may have in an RRC_IDLE state and a sub-state transition process.

Referring to FIG. 12, a UE performs an initial cell selection process (S801). The initial cell selection process may be performed when there is no stored cell information with respect to a PLMN or no suitable cell is found.

When no suitable cell is found in the initial cell selection process, the UE transitions to a random cell selection state (S802). The random cell selection state refers to a state in which the UE camps on neither a suitable cell nor an acceptable cell and attempts to find an acceptable cell of a random PLMN to camp on. When the UE finds no cell to camp on, the UE stays in the random cell selection state until an acceptable cell is found.

When a suitable cell is found in the initial cell selection process, the UE goes to a normal camp state (S803). The normal camp state refers to a state in which the UE camps on the normal cell, in which a paging channel is selected and monitored according to information provided through system information and an evaluation process for cell reselection may be performed.

When a cell reselection evaluation process (S804) is triggered in the normal camp state (S803), the cell reselection evaluation process (S804) is performed. When a suitable cell is found in the cell reselection evaluation process (S804), the UE goes back to the normal camp state (S803).

When an acceptable cell is found in the random cell selection state (S802), the UE goes to a random cell camp state (S805). The random cell camp state (S805) refers to a state in which the UE has camped on the acceptable cell.

In the random cell camp state (S805), the UE may select and monitor a paging channel according to information provided through system information, and may perform a cell reselection evaluation process (S806). When no acceptable cell is found in the cell reselection evaluation process (S806), the UE goes to the random cell selection state (S802).

Hereinafter, the present invention is described.

First, timers available in the present invention are described. The following table illustrates various timers used in the present invention.

TABLE 3

| Timer | Start | Stop | At expiry |
|---|---|---|---|
| T300 | Transmission of | Reception of RRCConnectionSetup | Upon performing MAC |
| | RRCConnectionRequest | or RRCConnectionReject message, | resetting, MAC setup |
| | | cell re-selection and upon abortion | release, and RLC re- |
| | | of connection establishment by | establishment |
| | | upper layers | |
| T310 | Upon detecting physical layer | Upon receiving N311 consecutive | If security is not |
| | problem for the PCell | in-sync indications from lower | activated: go to |
| | | layers for the PCell, upon triggering | RRC_IDLE |
| | | the handover procedure and upon | Else: initiate the |
| | | initiating the connection re- | connection re- |
| | | establishment procedure | establishment procedure) |
| T311 | Upon initiating the RRC | Selection of a suitable E-UTRA cell | Go to RRC-IDLE |
| | connection re-establishment | or a cell using another RAT | |
| | procedure | | |
| T312 | Triggering a measurement report | Upon receiving N311 consecutive | If security is not |
| | for a measurement identity for | in-sync indications from lower | activated: go to |
| | which T312 has been configured | layers, upon triggering the | RRC_IDLE |
| | while T310 is running | handover procedure, upon initiating | Else: initiate the |
| | | the connection re-establishment | connection re- |
| | | procedure, and upon the expiry of | establishment procedure |
| | | T310 | |

Meanwhile, suppose that a UE is RRC-connected with cell #1 and has a problem in a radio link with cell #1. For example, a physical layer problem is detected in the radio link with cell #1.

In this case, the UE starts timer T310 in Table 3. Suppose that the UE detects, while timer T310 is operating, that the signal strength and quality of cell #2 are higher than certain levels (event A3) or the signal strength and quality of cell #2 are higher than thresholds and the signal strength and quality of cell #1 are lower than the thresholds (event A5). Further, suppose that T312 is set for a measurement object/measurement ID associated with cell #2.

Then, when a measurement report with respect to cell #2 is triggered according to event A3 or A5, the UE starts T312.

Generally, an RLF is declared when T310 expires. In this case, however, the UE declares an RLF when T312 expires before the expiry of T310, which is called an early RLF declaration.

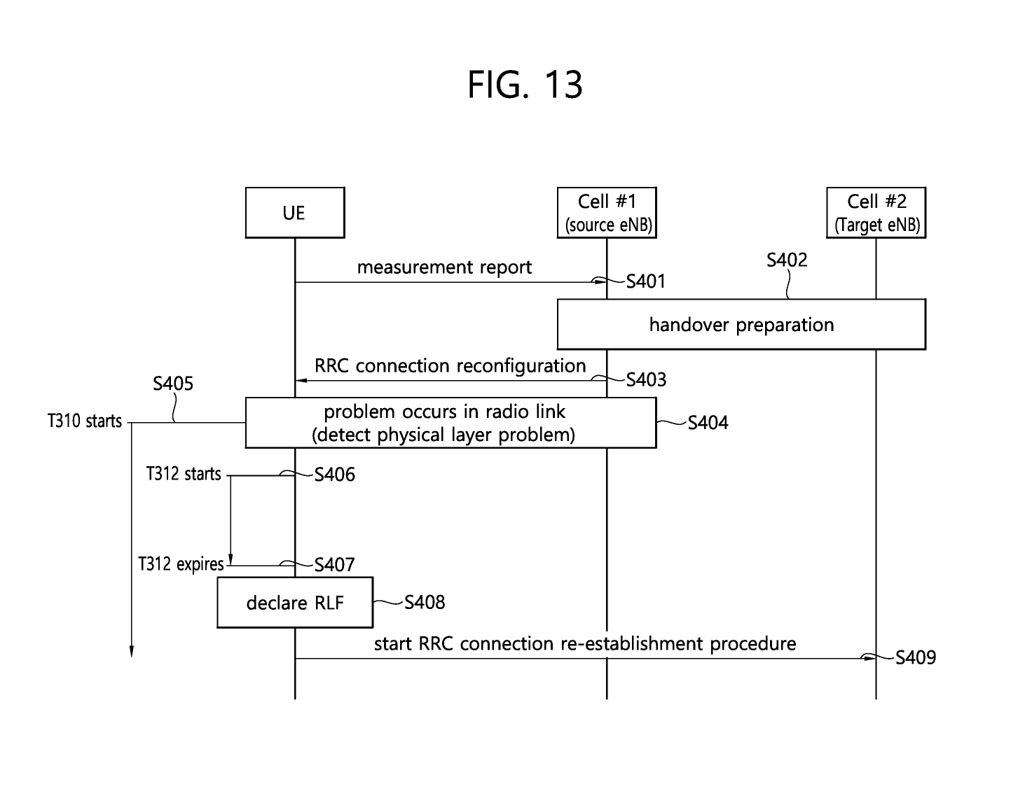

FIG. 13 illustrates an early RLF declaration.

Referring to FIG. 13, a UE is RRC-connected with cell #1. In this case, cell #1 may be referred to as a source cell or source eNB.

The UE transmits a measurement report to cell #1 (S401).

When the measurement report is received, cell #1 may prepare a handover to cell #2 based on the measurement report (S402).

When the handover is prepared, cell #1 may transmit an RRC connection reconfiguration for the handover to the UE (S403).

After the UE transmits the measurement report, a problem may occur in a radio link between cell #1 and the UE (S404). For example, the UE may detect a physical layer problem in the radio link with cell #1.

When the physical layer problem is detected, the UE starts T310 (S405).

Meanwhile, the UE may detect that a specific event with respect to cell #2 occurs while T310 is operating. For example, the occurrence of event A3 or A5 may be detected.

When T312 is set for a measurement object/measurement ID relating to cell #2, the UE starts T312 (S406). When T312 expires (S407), the UE declares an RLF even before the expiry of T310 (S408). After declaring the RLF, the UE starts an RRC connection re-establishment procedure with cell #2 (S409). That is, the UE makes an early RLF declaration. Accordingly, the RRC connection re-establishment procedure may be started earlier and user data interruption time may be reduced.

That is, suppose that the UE currently has a problem in a link with the current source cell, having determined that it is appropriate to perform a handover from the source cell to a target cell. In this case, it is more effective in reducing service interruption time that the UE declares an RLF and attempts to establish/reestablish an RRC connection to the target cell than that the UE attempts to restore the radio link with the current source cell. Accordingly, the UE makes an early RLF declaration.

However, there may be a problem in an early RLF declaration.

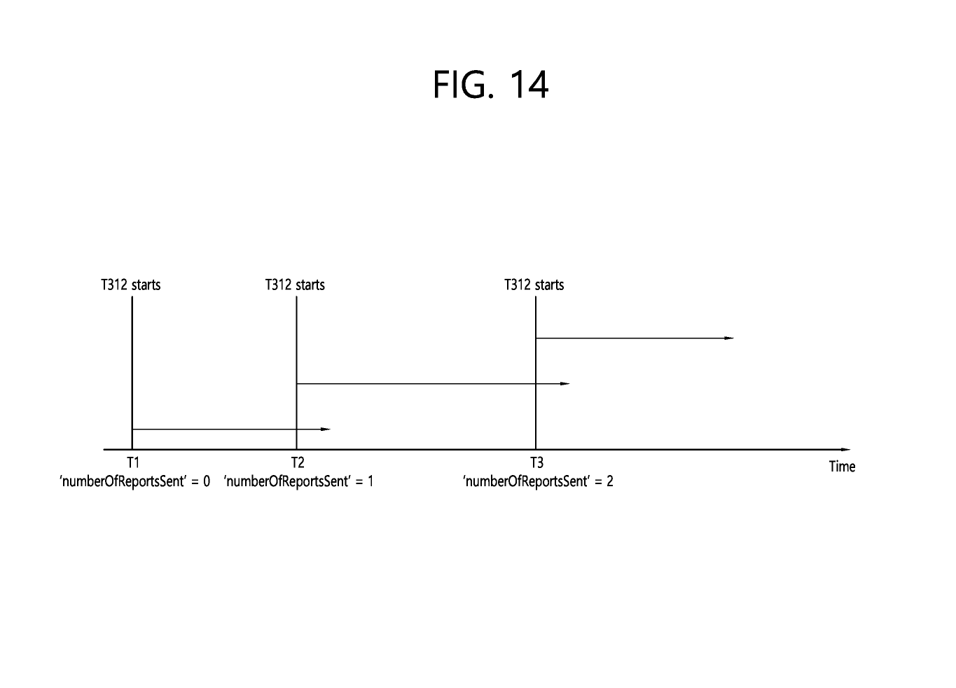

FIG. 14 illustrates a problem that may occur in an early RLF declaration.

Referring to FIG. 14, suppose that a UE has a problem in a radio link with a source cell (for example, cell #1 in FIG. 13). In this state, the UE may detect that a specific event with T312 set occurs with respect to a target cell (for example, cell #2 in FIG. 13). For example, event A3 or A5 may be detected. Accordingly, when performing a measurement report, the UE generates ‘VarMeasReportList’ that is a UE parameter including information on measurement satisfying a triggering condition.

The following table illustrates an example of ‘VarMeasReportList.’

```
TABLE 4
-- ASN1START
VarMeasReportList ::= SEQUENCE (SIZE (1..maxMeasId)) OF VarMeasReport
VarMeasReportList-r12 ::= SEQUENCE (SIZE (1..maxMeasId-r12)) OF
VarMeasReport
VarMeasReport ::= SEQUENCE {
        -- List of measurement that have been triggered
        measId MeasId.
        measId-v12xy MeasId-v12xy  OPTIONAL,
        cellsTriggeredList  CellsTriggeredList OPTIONAL,
        csi-RS-TriggeredList-r12 CSI-RS-TriggeredList-r12 OPTIONAL,
        numberOfReportsSent INTEGER
}
CellsTriggeredList ::= SEQUENCE (SIZE (1..maxCellMeas)) OF CHOICE {
        physCellIdEUTRA PhysCellId,
        physCellIdUTRA  CHOICE {
                fdd  PhysCellIdUTRA-FDD,
                tdd  PhysCellIdUTRA-TDD
        },
        physCellIdGERAN  SEQUENCE {
                carrierFreq CarrierFreqGERAN,
                physCellId PhysCellIdGERAN
        },
        physCellIdCDMA2000 PhysCellIdCDMA2000
}
CSI-RS-TriggeredList-r12 ::= SEQUENCE (SIZE (1..maxCSI-RS-Meas-r12)) OF MeasCSI-RS-Id-
r12
-- ASN1STOP
```

In the above table, ‘measId’ denotes a measurement ID, and ‘numberOfReportsSent’ denotes the number of times a measurement report is performed.

Referring to FIG. 14, ‘numberOfReportsSent’ of ‘VarMeasReportList’ may have a value of 0 at T1, ‘numberOfReportsSent’ of ‘VarMeasReportList’ may have a value of 1 at T2, and ‘numberOfReportsSent’ of ‘VarMeasReportList’ may have a value of 2 at T3.

Meanwhile, when the UE detects a specific event with respect to a measurement ID for which T312 is set and a measurement report is triggered, the UE starts T312. However, such event detection may be repeated, and the repetition of event detection may happen while T312 is operating, which is problematic.

For example, as illustrated in FIG. 14, suppose that the occurrence of event A3 with respect to cell #2 is repeatedly detected at T1, T2, and T3. Further, T312, which has been started at T1, may still be operating at T2. Furthermore, T312, which has been started at T2, may still be operating at T3. That is, starting T312 is repeated before the expiry of T312. Thus, T312 does not expire at an estimated time, resulting in a problem that an early declaration cannot be made.

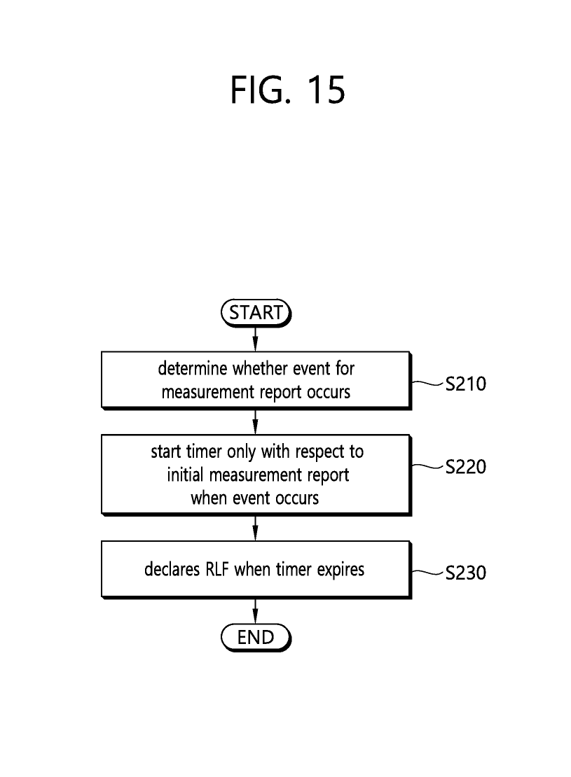

FIG. 15 illustrates an RLF declaration method of a UE according to one embodiment of the present invention.

Referring to FIG. 15, the UE determines whether an event for a measurement report occurs (S210). The event may be an event in which the signal strength or quality of a neighboring cell is better than that of a serving cell of the UE. For example, the event may be event A3 or A5.

When the event occurs, the UE starts a timer only with respect to an initial measurement report (S220). The UE does not start T312 with respect to a measurement report following the initial measurement report among measurement reports according to the event even though T310 is in operation.

Meanwhile, the timer may be T312 described above. Timer T312 may be used only when a specific event occurs. For example, a network may indicate a T312-applied event. Further, T312 may be used only when an event-based measurement report is triggered. T312 may be restricted not to be used when a periodic measurement report is triggered. When T312 is used even upon triggering a periodic measurement report, an RLF is detected even when it is not necessary to detect an RLF, causing a problem of extending service interruption time.

The UE may have received a measurement ID indicating an association between a reporting configuration, which indicates the event, and a measurement object, which indicates an object to be measured by the UE. The reporting configuration relating to the measurement ID may include a field indicating the use of the timer (which is called ‘useT312’). The ‘useT312’ field is applied to an event configuration. When this field is included in the reporting configuration, the UE needs to apply a ‘t312’ value specified for a corresponding measurement object to timer T312. If the corresponding measurement object includes no ‘t312’ value, T312 is considered not to be set.

The UE may start T312 only when the following conditions are satisfied with respect to a measurement ID for which a measurement report procedure is triggered.

That is, when 1) T310 is in operation, 2) T312 is set for the measurement ID and T312 is not in operation, 3) the reporting configuration relating to the measurement ID includes a field indicating the use of T312 (useT312), and 4) a parameter indicating the number of times a measurement report is sent (numberOfReportSent) is 0, the UE may start T312 with ‘t312’ set for the measurement ID with respect to the measurement ID for which the measurement report procedure is triggered.

When the timer expires, the UE declares an RLF (S230).

When the UE misses synchronization with the serving cell or has a problem in a radio link, for example, detects a physical layer problem, T310 is started. Further, when event A3 or A5 occurs to trigger a measurement report, the UE starts T312. T312 may have a shorter value than T310 and may be started only at an initial measurement report. When T312 expires, the UE declares an RLF and starts an RRC connection establishment/re-establishment procedure with the neighboring cell.

Accordingly, an increase in service interruption time caused by unnecessary transitions from the RRC connected state to the RRC idle state and then back to the RRC connected state with the serving cell may be prevented.

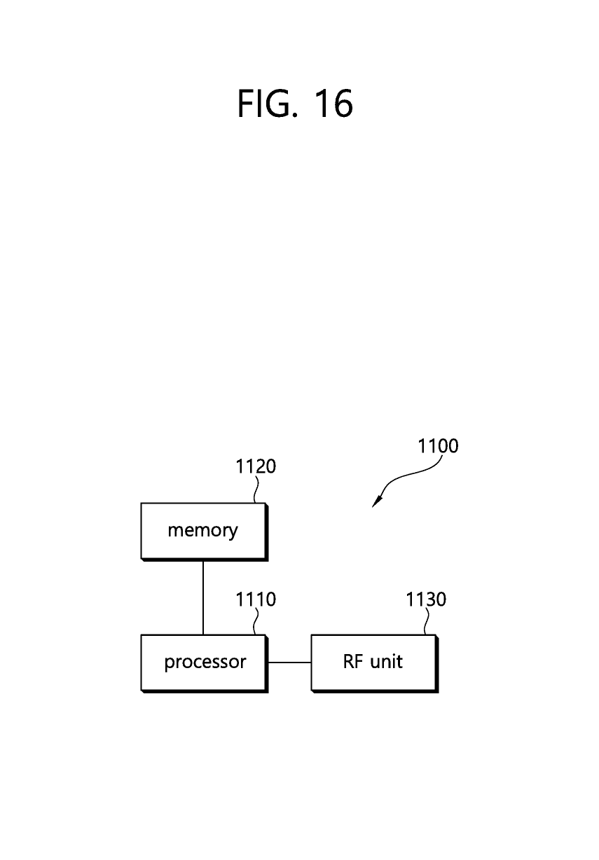

FIG. 16 is a block diagram of a UE according to an embodiment of the present invention.

Referring to FIG. 16, the UE 1100 includes a processor 1110, a memory 1120, and a radio frequency (RF) unit 1130. The processor 1110 implements the proposed functions, processes, and/or methods. For example, the processor 1110 may determine whether an event for a measurement report occurs, starts a timer only with respect to an initial measurement report when the event occurs, and declares an RLF when the timer expires.

The RF unit 1130 is coupled to the processor 1110 and transmits and receives a radio signal.

The processor may include Application-specific Integrated Circuits (ASICs), other chipsets, logic circuits, and/or data processors. The memory may include Read-Only Memory (ROM), Random Access Memory (RAM), flash memory, memory cards, storage media and/or other storage devices. The RF unit may include a baseband circuit for processing a radio signal. When the embodiments are implemented in software, the above-described scheme may be implemented using a module (process or function) which performs the above function. The module may be stored in the memory and executed by the processor. The memory may be disposed in or outside the processor and be connected to the processor using a variety of well-known means.

What is claimed is:

1. A method for declaring a radio link failure (RLF) performed by a user equipment (UE) in a wireless communication system, the method comprising:
determining whether an event for a measurement report occurs;
starting a timer only with respect to an initial measurement report when the event occurs; and
declaring an RLF when the timer expires.

2. The method of claim 1, further receiving a measurement identity indicating an association between a reporting configuration, which indicates the event, and a measurement object, which indicates an object to be measured by the UE.

3. The method of claim 2, wherein the reporting configuration relating to the measurement identity comprises a field indicating use of the timer.

4. The method of claim 1, wherein the event is an event in which a neighboring cell has better signal strength or quality than a serving cell of the UE.

5. The method of claim 1, wherein the UE generates a measurement report when the event occurs, and the measurement report comprises a field indicating number of report times.

6. The method of claim 5, wherein the timer is started only when the field indicating the number of report times has a value of 0.

7. A user equipment (UE), the UE comprises:
a radio frequency (RF) unit that transmit and receive a radio signal; and
a processor connected to the RF unit to operate,
wherein the processor that:
determines whether an event for a measurement report occurs,
starts a timer only with respect to an initial measurement report when the event occurs, and
declares an RLF when the timer expires.

8. The UE of claim 7, further receiving a measurement identity indicating an association between a reporting configuration, which indicates the event, and a measurement object, which indicates an object to be measured by the UE.

9. The UE of claim 8, wherein the reporting configuration relating to the measurement identity comprises a field indicating use of the timer.

10. The UE of claim 7, wherein the event is an event in which a neighboring cell has better signal strength or quality than a serving cell of the UE.

11. The UE of claim 7, wherein the UE generates a measurement report when the event occurs, and the measurement report comprises a field indicating number of report times.

12. The UE of claim 11, wherein the timer is started only when the field indicating the number of report times has a value of 0.
